(19) United States
(12) Patent Application Publication
(10) Pub. No.: US 2006/0038676 A1
(43) Pub. Date: Feb. 23, 2006

(54) Locating system

(76) Inventor: Anthony Richards, Hertfordshire (GB)

Correspondence Address: TRASK BRITT, P.O. BOX 2550, SALT LAKE CITY, UT, 84110, US

(21) Appl. No.: 11/205,608

(22) Filed: Aug. 17, 2005

(30) Foreign Application Priority Data
Aug. 18, 2004 (GB) 0418376.0

(51) Int. Cl. G08B 1/08

(52) U.S. Cl. 340/539.23

(57) ABSTRACT

A system for use in locating an object, comprising: a tag for placing with an object to be located, the tag comprising a first radio frequency communication module; and a locator device comprising a second radio frequency communication module for communicating with the tag. In one aspect, the locator device includes distance determining means for estimating separation between the tag and the locator device based on a status signal received from the tag; and alarm means for alerting a user when separation between the tag and the locator device falls below a predetermined distance. In another aspect, the locator device includes an output for providing information based on the estimated separation between the tag and the locator device provided by the distance determining means, with the tag and the locator device are configured to communicate with each another using a wireless specification based on IEEE 802.15.4.

### CROSS-REFERENCE TO RELATED APPLICATIONS

This application claims priority to related Great Britain Patent Application Serial No. GB 0418376.0 file Aug. 18, 2004, the disclosure of which is incorporated by reference herein in its entirety.

### BACKGROUND OF THE INVENTION

The present invention relates to a system for use in locating (e.g., monitoring position of) an object, e.g., a missing object.

Portable wireless locator systems for assisting in the location of missing articles (e.g., valuables such as keys and the like) are well known in the art. U.S. 2003/0034887 (Crabtree et al) discloses one such system. However, the wireless locator systems available on the market typically suffer from one or more of: a short range, a large physical size (both tag and locator device), a short battery-life and no directional capabilities. Accordingly, the present applicant has appreciated the need for an improved locator system which overcomes or at least alleviates the problems associated with the prior art.

### BRIEF SUMMARY OF THE INVENTION

In accordance with a first aspect of the present invention, there is provided a system for use in locating an object, comprising: a transceiver device for placing with an object to be located, the transceiver device comprising a first radio frequency communication module; and a locator device comprising: a second radio frequency communication module for communicating with the transceiver device; distance determining means for estimating separation between the transceiver device and the locator device based on a status signal received from the transceiver device; and alarm means for alerting a user when separation between the transceiver device and the locator device falls below a predetermined distance.

In this way, a system is provided for warning a user when an object (e.g., article, person or animal) associated with a transceiver device (hereinafter “tag”) enters within a predetermined range of the locator device. Advantageously, such a system may be employed as an aid for managing assets (e.g., in the workplace).

The tag may be configured to transmit a status signal in response to an activation signal received from the locator device. In one embodiment, the tag is configured to transmit a plurality of status signals (i.e., intermittently) in response to receipt of an activation signal. In this way, the tag may be configured to repeatedly transmit status signals whilst the tag is outside the predetermined distance.

The distance determining means may comprise a signal strength meter for measuring strength of status signals received from the tag. Since in normal use signal strength is generally assumed to be indicative of distance travelled by a radio frequency signal, separation between the tag and the locator device may be indirectly measured in this way. Accordingly, the alarm means may be configured to indicate when signal strength rises above a predetermined level.

The system may comprise one or more further tags as previously defined. For example, the system may comprise a total of up to 24 tags. In this way, the locator device may be used in locating a plurality of objects. Each tag may have a unique identification code associated therewith. In this way, the locator device may be configured to identify the identity of a tag activating the alarm means. For example, each tag may be configured to transmit a status signal which includes its own unique identification code. In one embodiment, the alarm means is configured to identify the specific tag causing the alarm. For example, the alarm means may comprise a visual display for displaying an alphanumeric identifier (e.g., tag number or name).

The unique identification codes of the tags may be stored in the locator device and the locator device may be configured to allow a user to select one or more tags to be located. The locator device may be configured to selectively address one or more of the tags. For example, the locator device may transmit an activation signal which includes the identification code of the selected tag. Upon receipt of the activation signal, a tag will compare the identification code contained in the transmitted activation signal with an identification code stored therein. If the two codes correspond, the tag will transit a status signal.

The activation signal may comprise a message packet including a tag identifier for identifying which of the plurality of tags is to be activated. In one embodiment, each tag is assigned a different bit in the tag identifier. For example, in a message packet having a tag identifier that is three bytes in length, up to 24 tags may be represented by the 24 available bits. In this way, up to 24 tags may be activated upon transmission of a single activation signal.

The locator device may also have an identification code associated therewith. Accordingly, the message packet may further comprise a locator device identifier. In one embodiment, the message packet may be reconfigurable to allow at least a portion of the locator device identifier to represent further tags. For example, in a message packet having a locator device identifier that is three bytes in length, one of the three bytes may be re-designated as an additional tag identifier. In this way, 6144 (i.e., 24×256) tags, for example, may be uniquely identified. In addition, a part of the locator device identifier may be re-designated to identify a group of tags. In this way, a group of tags may be readily selected for locating.

In accordance with a second aspect of the present invention there is provided a system for use in locating an object, comprising:
a transceiver device for placing with an object to be located, the transceiver device comprising a first radio frequency communication module; and
a locator device comprising: a second radio frequency communication module for communicating with the transceiver device; distance determining means for estimating separation between the transceiver device and the locator device using a status signal received from the transceiver device; and an output for providing information based on the estimated separation between the transceiver device and the locator device provided by the distance determining means.

In this way, a system is provided for use in locating (e.g., finding or monitoring position of) an object (e.g., article, person or animal) using a radio frequency (R.F.) communication system.

In one embodiment, the transceiver device and the locator device are configured to communicate with each another using a wireless specification based on IEEE 802.15.4. In this way, improved range capability and reduced power consumption may be advantageously achieved.

The transceiver device and locator device may be configured to distinguish between signals sent from the other respective device and signals sent from a device which is not part of the system. For example, the transceiver device and the locator device may each comprise IEEE 802.15.4-compliant components with their respective medium access control (MAC) settings configured to use a non-standard synchronisation codeword.

The IEEE 802.15.4 standard uses spread spectrum techniques at 2.4 GHz transmission frequency. The bit rate is 250 kb/s which allows small amounts of data to be transmitted in a short time. In light of the low power consumption of IEEE 802.15.4-compliant devices, the transceiver device may be powered by a battery of modest dimensions.

The distance determining means may comprise a signal strength meter for measuring strength of status signals received from the transceiver device (hereinafter “tag”). Since in normal use signal strength is generally assumed to be indicative of distance travelled by a radio frequency signal, separation between the tag and the locator device may be indirectly measured in this way.

In a first mode (hereinafter the “locate mode”), the output may be configured to provide an indication of the separation between the tag and the locator device. In this way, the system may operate to assist a user in locating a missing object.

In the locate mode, the output may be configured to display a visual indication of the estimated separation. For example, the output may comprise a Liquid Crystal display (LCD) screen for displaying a graphic indicative of approximate distance (e.g., a bar of variable height or length). In another form, the output may comprise one or more lights for indicating distance. For example, the output may comprise a plurality of lights, whereby the number of lights or the colour of lights illuminated is configured to be indicative of approximate distance. In addition, or instead, the output may comprise sound-generating means for providing an audio signal indicative of separation.

The locator device may further comprise a directional aerial. For example, the locator device may comprise an aerial defining an axis, the aerial being configured to receive a status signal from the tag at maximum strength when the axis is substantially aligned with the tag and a weaker signal when not so aligned. In this way, a user may obtain an indication of a direction or bearing of the tag (e.g., by sweeping the locator device around in a circle and finding the direction of strongest signal). The directional aerial may comprise a multiple-element Yagi array antenna. The directional antenna may have directional gain of substantially 8 dB.

In the locate mode, the tag may be configured to transmit a status signal in response to receipt of an activation signal from the locator device. The locator device may be configured to transmit a plurality of activation signals at a predetermined rate for the duration for which the input commands the communication module to transmit activation signals. In another embodiment, the transceiver device may be configured to transmit a series of reply signals in response to receipt of an activation signal. For example, the tag may continue to transmit reply signals until receipt of a subsequent signal from the locator device or until a predetermined period of time has elapsed.

In another mode (hereinafter the “alert mode”), the output may be configured to raise an alarm when the estimated separation between the tag and the locator device exceeds a predetermined distance. In this way, the system may operate to warn a user when a tag is leaving a predetermined range.

The tag may be configured to transmit a status signal in response to an activation signal received from the locator device. In one embodiment, the tag is configured to transmit a plurality of status signals (i.e., intermittently) in response to receipt of an activation signal. In this way, the tag may be configured to repeatedly transmit status signals whilst the tag is within the predetermined distance.

In embodiments where the distance determining means comprises a signal strength meter, the output raises an alarm when signal strength falls below a predetermined level.

In alert mode, the output may be configured to activate a further operation. For example, the output may activate a security device (e.g., a CCTV camera or the like). In this way, the alert mode may be used as a part of a security system for protecting valuables.

In yet another mode (hereinafter the “asset management mode”), the output may be configured to indicate when the estimated separation between the tag and the locator device falls below a predetermined distance. In this way, the system may operate to warn a user when a tag enters within a predetermined range of the locator device.

The tag may be configured to transmit a status signal in response to an activation signal received from the locator device. In one embodiment, the tag is configured to transmit a plurality of status signals (i.e., intermittently) in response to receipt of an activation signal. In this way, the tag may be configured to repeatedly transmit status signals whilst the tag is outside the predetermined distance.

In embodiments where the distance determining means comprises a signal strength meter, the output raises an alarm when signal strength rises above a predetermined level.

In yet another mode (hereinafter the “idle mode”), the tag is configured to switch intermittently between an inactive mode, in which the first radio frequency communication module is unresponsive to incoming signals, and an active mode, in which the first radio frequency communication module is responsive to incoming signals. In this way, the power consumed by the tag may be minimised during periods of inactivity.

In order to ensure that signals sent by the locator device are received by the tag, the duration of signals sent by the locator device to the tag when in idle mode should be longer than the length of inactive mode.

The system may be configured to operate in one or more of the modes hereinbefore defined. In the case of a system configured to operate in one of a plurality of modes, the locator device may include a selector for switching between modes. In the case of the idle mode, the tag may be placed in this mode automatically after completion of another mode.

The system may comprise one or more further tags as previously defined. For example, the system may comprise a total of up to 24 tags. In this way, the locator device may be used in locating a plurality of objects. Each tag may have a unique identification code associated therewith. In this way, the locator device may be configured to identify the identity of a tag being located (e.g., location monitored in alert mode). For example, each tag may be configured to transmit a status signal which includes its own unique identification code. In one embodiment, the alarm means is configured to identify the specific tag causing the alarm. For example, the output may comprise a visual display for displaying an alphanumeric identifier (e.g., tag number).

The unique identification codes of the tags may be stored in the locator device and the locator device may be configured to allow a user to select one or more tags to be located. The locator device may be configured to selectively address one of the devices. For example, the locator device may transmit an activation signal which includes the identification code of the selected tag. Upon receipt of the activation signal, a tag will compare the identification code contained in the transmitted activation signal with an identification code stored therein. If the two codes correspond, the tag will transit a status signal in accordance with a selected mode of operation.

The activation signal may comprise a message packet including a tag identifier for identifying which of the plurality of tags is to be activated. In one embodiment, each tag is assigned a different bit in the tag identifier. For example, in a message packet having a tag identifier that is three bytes in length, up to 24 tags may be represented by the 24 available bits. In this way, up to 24 tags may be activated upon transmission of a single activation signal.

In use, a system comprising one or more further tags may be configured such that the location of one tag may be monitored in one mode whilst another tag is monitored in a different mode. However, alert mode may suspended when locate mode is activated. In this way, a user is able to concentrate on the task of locating an object without the distraction of alarms being set off by the alert or asset management modes.

### BRIEF DESCRIPTION OF THE SEVERAL VIEWS OF THE DRAWINGS

An embodiment of the invention is diagrammatically illustrated, by way of example, in the accompanying drawings, in which:

FIG. 1 is schematic representation of a system according to the present invention; and

FIG. 2 is a schematic representation of the component parts of the system of FIG. 1.

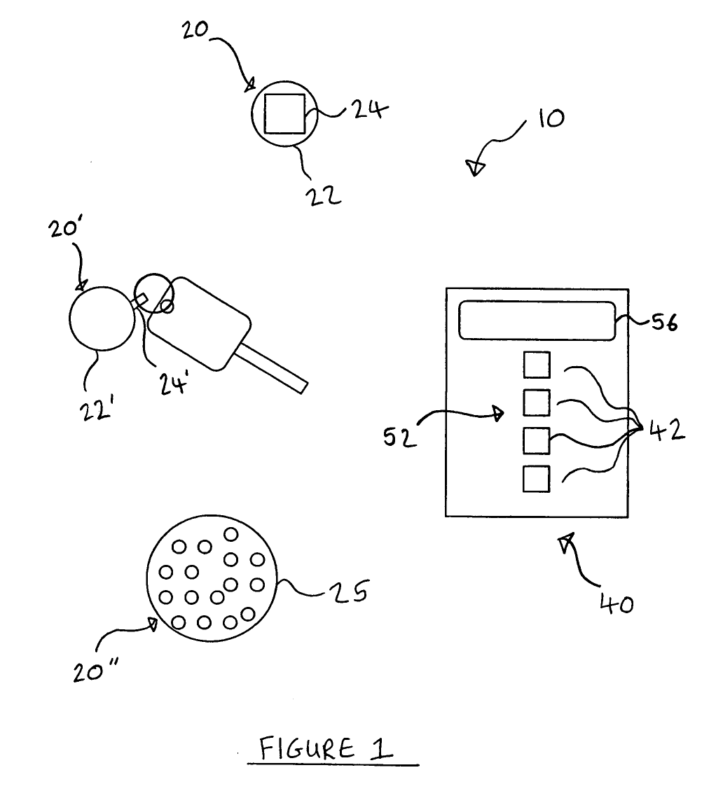

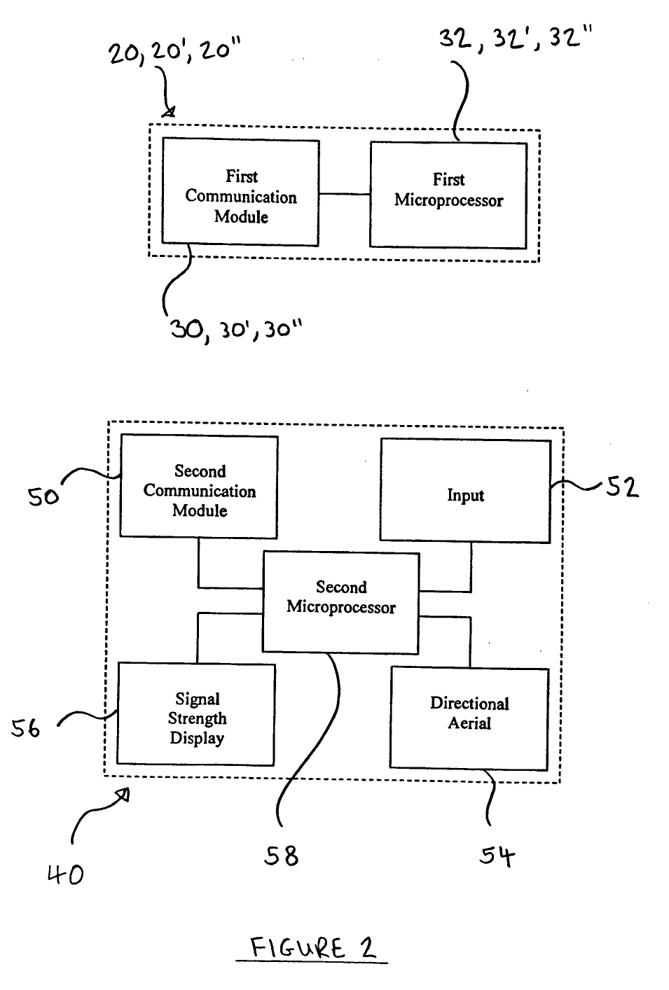

FIGS. 1 and 2 show a system 10 comprising a plurality of tags 20, 20′ and 20″ and a locator device 40. Each tag may be associated with an object to be located in a variety of ways. In one embodiment, the tag comprises a casing configured to be attached to or carried by an object to be located. The casing may comprise means for attaching the transceiver device to an object to be located. The attachment means may comprise an adhesive layer. For example, the attachment means may comprise a peelable adhesive layer or a Velcro pad for removeably attaching the tag to an object. In this way, the tag may be reused to locate many different objects over time. In another form, the attachment means may be configured for attaching the tag to a key ring or the like. In another embodiment, the tag may be housed in the object itself. For example, the transceiver device may be housed in a golf ball, car key, camera or the like.

### DETAILED DESCRIPTION OF THE INVENTION

In the embodiment illustrated, tag 20 comprises a casing 22 comprising an adhesive layer 24 for attachment to an everyday article (e.g., wallet or the like). Tag 20′ takes the form of a key-ring accessory 22′ comprising attachment means 24′ having an aperture for receiving a key-ring. Tag 20″ is configured to be integrally mounted within a golf ball 25 during manufacture. Each tag 20, 20′ and 20″ has its own unique identification code associated therewith to allow the locator device 40 to locate one or more specific tag. Transceiver devices 20, 20′ and 20″ each comprise a first R.F. communication module 30, 30′ and 30″ and a first processor 32, 32′ and 30″ (depicted as a single unit in FIG. 2 only for the sake of brevity).

The locator device 40 may be a portable device, e.g., a handset. In one form, the locator device 40 may be incorporated in a hand-held device such a Personal Digital Assistant (P.D.A.), an electronic organiser, an MP3 player, mobile telephone or the like.

The locator device 40 comprises a second R.F. communication module 50 which includes an omni-directional aerial, an input 52 (in the form of buttons or keys 42 shown in FIG. 1 which may include Braille markings), a directional aerial 54 and an output 56 all linked to a second microprocessor 58 which includes distance determining means. Output 56 includes an LCD including a graphic representative of signal strength and alarm means configured to produce an audio and/or visual alarm. Additional audiovisual aids (not shown) may be provided on both the locator device and tags to aid locating tagged objects. For example, each tag may be configured to emit a unique tone.

For optimum high range capability and low power-consumption, the first and second communication modules preferably operate using a specification based on the IEEE 802.15.4 standard. The IEEE 802.15.4 standard uses spread spectrum techniques at 2.4 GHz transmission frequency. The bit rate is 250 kb/s which allows small amounts of data to be transmitted in a short time. In light of the low power consumption of IEEE 802.15.4-compliant devices, the transceiver device may be powered by a battery of modest dimensions.

Using a specification based on the IEEE 802.15.4 standard, the first and second communication modules may have a maximum range of between 100 m and 200 m. For example, the first and second communication modules may have a maximum range of between 125 m and 175 m. However, it is conceivable that other suitable protocols (e.g., ZigBee™ or Bluetooth) may be used to implement the present invention.

Modes of operation of the system 10 and details of the structure of message packets transmitted between the locator device 40 and tags 20, 20′, 20″ are described in detail below.

Summary of Modes

The locator device 40 is configured to operate in a plurality of modes, namely: “idle mode,” “locate mode,” “alert mode,” “asset management mode” and “treasure hunt mode.” Locate mode is used to give audio and/or visual feedback to the user about the position of an object (e.g., missing object), thereby helping to direct the user to the object. Alert mode alerts the user when an object travels beyond a set allowed perimeter. In asset management mode, the locator device maintains a fixed position, and tags that come within a certain distance set off an alarm. In treasure hunt mode (which is functionally identical to asset management mode) it is the user who moves around with the locator device and an alarm is sounded if a tag comes within a certain range of the locator device. Idle mode is the state in which tags reside when they are not being communicated with or used to find items, so as to save battery life. The five modes, and the way they operate will now be discussed in more depth.

Message Packets

Most message packets for the system exchanged between locator device and tags will follow the same message structure, and an example structure is shown.

| Byte | | | | | | |
|---|---|---|---|---|---|---|
| 1 | 2 | 3 | 4 | 5 | 6 | 7 |

| | | | |
|---|---|---|---|
| Description | Message ID | Tag number | 3 byte handheld ID number |

One byte is required to carry the message identifier, describing what the rest of the data in the packet refers to. The other 6 bytes of the packet are data, and this is split down into two sections. The first section is the 3-byte tag number. The second that is also 3-bytes long carries information about the locator device ID number.

In the system there are a maximum of 24 tags that belong to any one locator device, and this information is incorporated into the tag number field of the message packet. By using three bytes for this field, one bit can be assigned to each device. This allows downstream transmissions from locator device to tag to address more than one tag, whereas upstream transmissions from tag to locator device will only show the tag number that sent the message.

Tag Wake-Up

Tags that are not currently in an active (for example Locate) mode reside in idle mode. In idle mode, the tag polls the air interface every few seconds to determine if the locator device is communicating with it. If the tag finds the air interface in use, then it wakes up. This polling period is called the tag wake-up interval. The wake-up interval is designed to minimise battery consumption by switching off parts of the tag when they are not needed.

The wake-up period must be catered for in the locator device system design. Every transmission from locator device to a tag in idle mode must be longer than the tag wake-up interval to ensure that the tag wakes up.

Tag Registration

The registration process is invoked by the locator device. The locator device sends a continuous stream of ‘register request’ messages to the tag for a period in excess of the tag wake-up interval. When the tag wakes up and receives one or more such messages, it will either respond unconditionally if it is unregistered, or will respond if the identity of the originating locator device matches that already programmed into the tag (or a master locator device ID).

If the tag is unregistered or recognises the locator device ID in the ‘register request’ message, it sends an accept request back to the locator device. The message is repeated frequently, so that once the locator device ceases its repeated transmission, it will receive the acknowledgement.

If the locator device receives a valid acknowledgement from a single tag, the locator device sends the ‘register’ message to the tag containing the registration number. This register message carries the unique ID for the locator device, which is then stored in the tag. It also carries the assigned tag number, by which the locator device recognises the tag. The tag then responds finally with a registration result (success or failure), which results in an audiovisual response to the user.

All the messages during the message registration handshake must be of high signal strength to ensure that the separation between locator device and tag is between a minimum distance and a maximum distance. Only units separated by this range should reply to registration messages. However, tags up to twice the maximum distance from the locator device may respond to the requests, due to variations in RF performance.

A time delay is incorporated between the locator device accepting the registration acknowledgement message from the tag, and sending the registration data. If two or more tags accept the request, the locator device cancels the registration process to stop two tags getting the same registration data. If only one tag accepts the request during the delay time, the registration process is completed.

A tag can only be registered to one locator device at a time, so pre-registered tags need to be unregistered by the parent locator device (with matching ID), or a master locator device (with specific foreign ID) before they can be re-registered. The tag initially comes unregistered, and must be registered before use. The registration data (ID & tag number) are stored on the tag in non-volatile memory so that when batteries are changed, the registration data is not lost. When tags are unregistered by the locator device, data is set back to the factory default.

A total of 24 tags may be registered to one locator device, using all of the tag addressing slots in the message packet. The non-volatile memory on the locator device is used to store a name for each of the 24 tags, to assist the user in associating particular tags to assigned functions.

Locate Mode

A locate mode is provided to help the user to locate a specific tag. The user initiates the “locate mode” on the locator device, and the tag listens for locate messages. The locator device will transmit the locate message continuously at first, and then with gaps, to allow the locator device to receive responses from the tag to the locate message. A tag initially in idle mode will enter locate mode upon receiving a valid locate message from the locator device, causing the tag to continually transmit locate messages to the locator device at a constant rate.

A tag in alert mode switches to locate mode when it receives a locate message from the locator device. The locator device then responds every time a reply is received with another locate message to keep the tag in locate mode. A tag will stay in locate mode whilst receiving the constant locate messages from the locator device, or otherwise time out after a set period. The locator device will stay in locate mode until a timeout is reached, or the user ceases to locate, switches tag or changes mode. At this point, the tag is brought from locate mode into idle mode with the transmission of an idle message.

If the user stops locating the current tag, the locator device sends the idle message, however if the user switches tag then the new locate message to another tag is inferred as an idle message to the previous tag.

Tags in locate mode alert the user with audiovisual emissions. These both occur between 0.5 and 2 times per second.

Example Locate Message Structure

The locate message from locator device to tag will have a message ID stating that it is a ‘locate’ message. The locator device ID will take the value of the locator device's unique ID number that is registered with a tag, and the tag number will take the value of the tag to put into locate mode. This locate message starts locate mode, and starts the operation described in the locate mode section.

The tag then responds with messages with a ‘hello’ message ID. This contains the same data as the initial locate message, so that the locator device knows that the message is bound for it, and so that it knows its tag number. It uses the hello message as described in the locate mode section, to determine the position of the object. There may be three factory settings in alert mode/asset management mode: “near,” “medium,” and “far.” Users may be able to alter sensitivity of the factory settings, for example to make “near” very close to “medium.” Factoring “far” may be set at 75% of maximum; a user could change the setting to, for example, 99%.

Alert Mode

Alert mode is provided to tell the user when a tag moves outside a maximum configurable distance. The mechanism for detecting this condition is to monitor the received power of messages sent from tag to locator device, and infer the distance from the received power. There are three different configurable distances to the user in alert mode.

Alert mode is initiated by the locator device, for any subset of the tags belonging to that locator device. This subset forms an ‘alert list’. If the locator device leaves alert mode, the alert list is remembered for when the mode is re-entered. When the user initiates alert mode, the locator device issues message waking tags from idle mode and places them in alert mode. If there are no tags on the alert list, the locator device maintains radio silence, and awaits information from the user about which tags to put onto the alert list and into alert mode.

A tag in idle or locate mode is switched to alert mode if a valid alert message is received. A tag in alert mode sends messages periodically to the locator device so that the distance can be calculated between the tag and the locator device. The tag continues to transmit until the locator device tells the tag to leave alert mode, and return to idle mode or enter another mode. When in alert mode, the tag does not give out any audiovisual signals, however when entering alert mode a short audiovisual signal is given.

The locator device unit remains in alert mode until the user intervenes. When in alert mode it processes the tag responses. If the locator device receives any message from any tag not on the alert list, a message is used to make that tag enter idle mode.

The locator device alerts the user when a tag goes past a distance threshold, or if (for example) two or more messages fail to reach the locator device. If the condition that made the locator device alert the user is cleared, then the alert is cleared. Any tag in the alert condition is added to the ‘alarm list’, and, when alarm list is not empty, an alarm condition is given to the user. The alarm condition causes an audiovisual output on the locator device, with a timeout and interactive options for the user to pursue. The locator device also has a timeout to check if alert mode has been active for a long period of time. The alert mode alarm may include an audio and/or visual output and/or a vibrating element.

Example Alert Message Structure

The alert message from the locator device to tag has a unique message ID telling the tag(s) that it is an alert message. This causes the tag(s) to enter alert mode that are indicated in tag number bit field and that are registered to the locator device ID field.

In alert mode the tags periodically send a message with ID of ‘hello’ to the locator device, the same ID used in locate mode. The ID field is filled with the locator device's ID, and the tag number of the tag responding. This is used as described in the alert mode section to determine the distance between tag and locator device.

Asset Management/Treasure Hunt Mode

Asset management mode provides a user with a proximity warning, to raise an alarm when assets (objects that have been tagged) come within a certain range of the locator device. Treasure hunt mode similarly raises an alarm when tagged objects come within a certain range of the locator device, however in treasure hunt mode, the locator device is assumed to be mobile, rather than the tags. The combined mode is abbreviated to Treasure Hunt and Asset Management (THAM). THAM comes in (for example) two variants, (for example) THAM-24 and THAM-256, and have different message structures for the two variants.

In a similar fashion to alert mode, the received message power on a message transmitted from tag to locator device is analysed to calculate the distance between tag and locator device.

Asset Management/Treasure Hunt 256 Mode

To use asset management and treasure hunt 256 mode “THAM-256,” the system must be set up to use a different ID structure to the normal 3-byte ID structure. The first of the three bytes is set to the unique foreign ID. The user enters a second “THAM group” number into the locator device, which is used as an ID between locator device and tags. The third byte called the “THAM subgroup” is individually assigned to each tag, as is the tag number. These numbers can then be used to register tags.

| Byte | | | | | | |
|---|---|---|---|---|---|---|
| 1 | 2 | 3 | 4 | 5 | 6 | 7 |

| | | | | | |
|---|---|---|---|---|---|
| Description | Message | Tag number | Foreign | THAM | THAM |
| | ID | | ID | group | subgroup |

An unlocking function is envisaged to allow the locator device to enter this THAM-256 mode, and change the ID structure. Only an unlocked locator device can register a tag as foreign, and only a locator device with the same THAM number, or a master locator device, can re-register the tag later.

Once the locator device has been given the foreign ID and THAM group number, and it has registered tags, it can be used in either THAM mode. The locator device issues a message to make all tag(s) with the same THAM group number enter alert mode, and the tags in this group respond periodically with a reply signal. When a tag comes within a user specified distance of the locator device, an audiovisual alert is given. In asset management mode this will occur because the tag has moved too close to the locator device, and in treasure hunt mode because the locator device has moved close to the tag. The locator device will then display the THAM subgroup number, and the tag number, so that the tag is uniquely identified.

In asset management mode, it is envisaged that there will not be two tags with the same THAM subgroup number and tag number, so that (for example) 24*256=6144 devices can be uniquely identified. In treasure hunt mode, the tag number could be used to signify different values of treasure that have been found, and the THAM subgroup number is used to identify the (name of the) treasure.

As in alert mode, there are (for example) three configurable distances at which the tag can be identified as being close to the locator device. It is envisaged that THAM-256 mode can work alongside Alert mode (using foreign ID's), alerting if the object is too close or too far. It would however be suspended in Locate mode. Due to the fact that the locator device has a foreign ID, the standard 3-byte ID locate and alert mode are no longer accessible. Other tags with standard 3-byte ID's in alert mode will be left unaffected, and the locator device will ignore their alerts.

The locator device may also be able to take the THAM group number of a tag that it heard broadcasting the alert signal.

Asset Management/Treasure Hunt 256 Mode Message Structure

An alert message is sent from the locator device containing the foreign ID and THAM group number. Any foreign registered tag(s) that match the THAM group number enter alert mode. The tag(s) in alert mode then periodically send a ‘hello’ message back to the locator device with foreign ID, THAM group number, THAM subgroup number and tag number. The locator device uses the responses as described in the THAM section to determine distance between tag and locator device.

Asset Management/Treasure Hunt 24 Mode

THAM 24 reverts back to the original 3-byte unique device ID. The locator device with registered tags signals the tags to enter alert mode. As all the tag(s) will have the same unique 3-byte ID, the 3-byte tag number is used to choose which tag(s) enter alert mode. The locator device then monitors the responses from tags, using the received power to calculate the distance between tag and locator device. When a tag comes within the range specified by a setting on the locator device, the locator device gives an audiovisual response and displays the tag number.

Asset Management/Treasure Hunt 24 Mode Message Structure

The alert message is given from locator device to tag(s), using the unique 3-byte ID. The tag numbers in the message are used to specify which tag(s) are to enter alert mode. The tags then enter alert mode, sending a message with ID ‘hello’ periodically. The received messages are checked to be valid against the 3-byte ID, and used to determine the distance between tag and locator device. This information is used as described in the Asset Management/Treasure Hunt 24 Mode section.

Panic Button and Messages

A special variant of a normal tag may be fitted with a ‘panic’ button. The panic function may form a special case of the alert mode. When the tag is in alert mode, and the alert signals being monitored by the locator device, pressing the panic button sends a message with a different ID to the locator device. This causes the locator device to immediately enter an alert condition and put the tag that pressed the panic button onto the alarm list. The message takes the standard packet format, so that the locator device can identify which tag pressed the panic button from the tag field. The tag will also give an audiovisual alert when in panic mode.

What is claimed is:

1. A system for use in locating an object, comprising:
a transceiver device for placing with an object to be located, the transceiver device comprising a first radio frequency communication module; and
a locator device comprising: a second radio frequency communication module for communicating with the transceiver device; distance determining means for estimating separation between the transceiver device and the locator device based on a status signal received from the transceiver device; and alarm means for alerting a user when separation between the transceiver device and the locator device falls below a predetermined distance.

2. A system according to claim 1, wherein the transceiver device is configured to transmit a status signal in response to an activation signal received from the locator device.

3. A system according to claim 2, wherein the transceiver device is configured to transmit a plurality of status signals in response to receipt of an activation signal.

4. A system according to claim 1, wherein the distance determining means comprises a signal strength meter for measuring strength of status signals received from the transceiver device.

5. A system according to claim 1, further comprising one or more further transceiver devices each comprising a respective radio frequency communication module.

6. A system according to claim 5, wherein each transceiver device has a unique identification code associated therewith.

7. A system according to claim 6, wherein the locator device is configured to identify the identity of a transceiver device activating the alarm means.

8. A system according to claim 6, wherein the locator device is configured to selectively address one or more of the transceiver devices.

9. A system according to claim 6, wherein the activation signal comprises a message packet including a tag identifier for identifying which of the plurality of transceiver devices is to be activated.

10. A system according to claim 9, wherein each transceiver device is assigned a different bit in the tag identifier.

11. A system according to claim 1, wherein the transceiver device and the locator device are configured to communicate with each another using a wireless specification based on IEEE 802.15.4.

12. A system for use in locating an object, comprising:
a transceiver device for placing with an object to be located, the transceiver device comprising a first radio frequency communication module; and
a locator device comprising: a second radio frequency communication module for communicating with the transceiver device; distance determining means for estimating separation between the transceiver device and the locator device using a status signal received from the transceiver device; and an output for providing information based on the estimated separation between the transceiver device and the locator device provided by the distance determining means;
wherein the transceiver device and the locator device are configured to communicate with each another using a wireless specification based on IEEE 802.15.4.

13. A system according to claim 12, wherein the transceiver device and locator device are configured to distinguish between signals sent from the other respective device and signals sent from a device which is not part of the system.

14. A system according to claim 12, wherein the distance determining means comprises a signal strength meter for measuring strength of status signals received from the transceiver device.

15. A system according to claim 12, wherein the locator device further comprises a directional aerial.

16. A system according to claim 12, wherein the output is configured to provide an indication of the separation between the transceiver device and the locator device.

17. A system according to claim 12, wherein the output is configured to raise an alarm when the estimated separation between the transceiver device and the locator device exceeds a predetermined distance.

18. A system according to claim 12, wherein the output is configured to indicate when the estimated separation between the tag and the locator device falls below a predetermined distance.

19. A system according to claim 12, wherein the transceiver device is configured to switch intermittently between an inactive mode, in which the first radio frequency communication module is unresponsive to incoming signals, and an active mode, in which the first radio frequency communication module is responsive to incoming signals.

20. A system according to claim 12, further comprising one or more further transceiver devices each comprising a respective radio frequency communication module.

21. A system according to claim 20, wherein each transceiver device has a unique identification code associated therewith.

22. A system according to claim 21, wherein the locator device is configured to identify the identity of a transceiver device activating the output.

23. A system according to claim 21, wherein the locator device is configured to selectively address one or more of the transceiver devices.

24. A system according to claim 21, wherein the activation signal comprises a message packet including a tag identifier for identifying which of the plurality of transceiver devices is to be activated.

25. A system according to claim 24, wherein each transceiver device is assigned a different bit in the tag identifier.
